(19) United States
(12) Patent Application Publication
(10) Pub. No.: US 2026/0103476 A1
(43) Pub. Date: Apr. 16, 2026

(54) Zinc Metal-Organic Framework Material and Use of the Same

(71) Applicant: Ming Chi University of Technology, New Taipei City (TW)

(72) Inventors: Yi-Ting Lai, New Taipei City (TW); Dhanaprabhu Pattappan, New Taipei City (TW)

(21) Appl. No.: 19/045,683

(22) Filed: Feb. 5, 2025

(30) Foreign Application Priority Data
Oct. 14, 2024 (TW) 113138989

(51) Int. Cl. C07F 3/06; C01B 3/04; C02F 1/30

(52) U.S. Cl. CPC C07F 3/06; C01B 3/042; C02F 1/30; C02F 2305/10

(57) ABSTRACT

A zinc metal-organic framework (Zn-MOF) material includes a zinc ion, a benzene-1, 4-dicarboxylic acid ligand coordinated to the zinc ion, and a 2-acetoxybenzoic acid ligand coordinated to the zinc ion. The benzene-1, 4-dicarboxylic acid ligand is derived from benzene-1, 4-dicarboxylic acid which is formed by subjecting a waste polyethylene terephthalate (PET) to an alcoholysis reaction. Methods for photocatalytic degradation of tetracycline and for producing hydrogen using the Zn-MOF material are also provided.

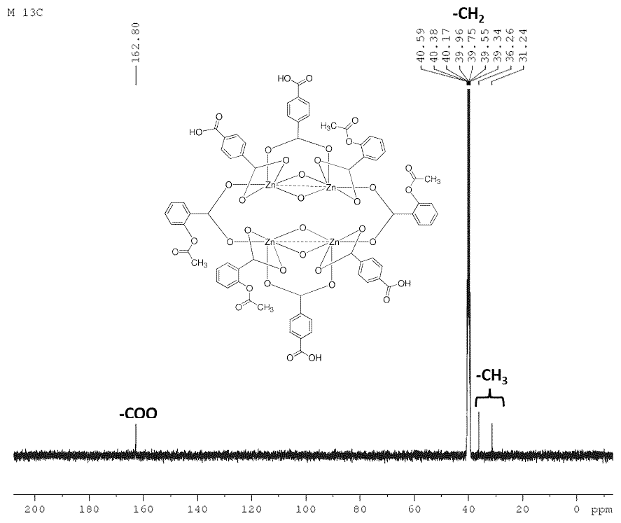

### CROSS-REFERENCE TO RELATED APPLICATION

This application claims priority to Taiwanese Invention Patent Application No. 113138989 filed Oct. 14, 2024, the disclosure of which is hereby incorporated by reference in its entirety.

### BACKGROUND OF THE DISCLOSURE

### Field of the Disclosure

The present disclosure relates to a metal-organic framework (MOF) material, and more particularly to a zinc metal-organic framework (Zn-MOF) material and methods for photocatalytic degradation of tetracycline and for producing hydrogen using the Zn-MOF material.

### Description of Related Art

Polyethylene terephthalate (PET) is widely utilized in daily necessities, such as beverage bottles, containers for cleaning products, etc., due to good mechanical properties and heat resistance thereof. Such application brings convenience to people's lives, but at the same time, an amount of a PET waste is increasing day by day, and hence causes a negative impact on the environment that cannot be ignored. Predominant disposal methods for the daily necessities containing the PET are landfill and incineration, either one of which contributes to environmental pollution.

In light of rising awareness of environmental protection, and in order to facilitate recycling of waste PET bottles, A. M. AI-Enizi et a/. (2020), J. Clean. Prod., doi: 10.1016/j.jclepro.2019.119251 discloses a zinc-based metal-organic framework-5 (hereafter abbreviated as MOF-5) which includes a zinc ion and a benzene-1, 4-dicarboxylic acid ligand coordinated to the zinc ion. The benzene-1, 4-dicarboxylic acid ligand is derived from benzene-1, 4-dicarboxylic acid which is formed by subjecting a waste PET bottle to an alcoholysis reaction.

In addition to the increasing amount of the PET waste as mentioned above, improper disposal of expired, spoiled, or long-term unused medications may also contribute to environmental and water pollution. Current research indicates that wastewater in sewage systems often contains sulfonamide antibiotics, tetracycline antibiotics, and/or quinolone antibiotics, among which the tetracycline antibiotics are the most commonly used. Since the tetracycline antibiotics are not readily biodegradable and have biological inhibition properties, degradation of the tetracycline antibiotics has become a major focus of concern.

It has been reported in S. M. Mirsoleimani-azizi et al. (2018), J. Environ. Chem. Eng., doi: 10.1016/j.jece.2018.09.017 that MOF-5 can serve as an adsorbent for removal of tetracycline. Although the MOF-5 could be used to remove the tetracycline, a removal effect of MOF-5 failed to meet required standards.

In view of the aforesaid, there is still a need to develop a metal-organic framework material which is made from a PET waste and has several advantages, e.g., having a relatively high degradation rate of tetracycline, and hence can effectively remove the tetracycline.

### SUMMARY OF THE DISCLOSURE

Therefore, in a first aspect, the present disclosure provides a zinc metal-organic framework (Zn-MOF) material, which can alleviate at least one of the drawbacks of the prior art. The Zn-MOF material includes a zinc ion, a benzene-1, 4-dicarboxylic acid ligand coordinated to the zinc ion, and a 2-acetoxybenzoic acid ligand coordinated to the zinc ion. The benzene-1, 4-dicarboxylic acid ligand is derived from benzene-1, 4-dicarboxylic acid which is formed by subjecting a waste polyethylene terephthalate (PET) to an alcoholysis reaction.

In a second aspect, the present disclosure provides a method for photocatalytic degradation of tetracycline, which can alleviate at least one of the drawbacks of the prior art, and which includes subjecting a medium containing tetracycline to a photocatalytic degradation under light in the presence of the aforesaid Zn-MOF material, so as to degrade the tetracycline in the medium.

In a third aspect, the present disclosure provides a method for producing hydrogen, which can alleviate at least one of the drawbacks of the prior art, and which includes subjecting water to a hydrogen evolution reaction in the presence of the aforesaid Zn-MOF material and an alkaline medium, so as to produce hydrogen.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

The sole FIGURE of this application shows the carbon-13 nuclear magnetic resonance (¹³C NMR) spectrum of the zinc metal-organic framework (Zn-MOF) material of Example 1 (EX1).

### DESCRIPTION OF NON-LIMITING EMBODIMENTS OF THE DISCLOSURE

For the purpose of this specification, it will be clearly understood that the word “comprising” means “including but not limited to”, and that the word “comprises” has a corresponding meaning.

It is to be understood that, if any prior art publication is referred to herein, such reference does not constitute an admission that the publication forms a part of the common general knowledge in the art, in Taiwan or any other country.

Unless otherwise defined, all technical and scientific terms used herein have the meaning commonly understood by a person skilled in the art to which the present disclosure belongs. One skilled in the art will recognize many methods and materials similar or equivalent to those described herein, which could be used in the practice of the present disclosure. Indeed, the present disclosure is in no way limited to the methods and materials described.

The present disclosure provides a zinc metal-organic framework (Zn-MOF) material which includes a zinc ion, a benzene-1, 4-dicarboxylic acid ligand coordinated to the zinc ion, and a 2-acetoxybenzoic acid ligand coordinated to the zinc ion. The benzene-1, 4-dicarboxylic acid ligand is derived from benzene-1, 4-dicarboxylic acid which is formed by subjecting a waste polyethylene terephthalate (PET) to an alcoholysis reaction.

In certain embodiments, a millimolar ratio of the benzene-1, 4-dicarboxylic acid ligand to the zinc ion is 2:5.

In certain embodiments, a millimolar ratio of the 2-acetoxybenzoic acid ligand to the zinc ion is 2:5.

In certain embodiments, the Zn-MOF material is

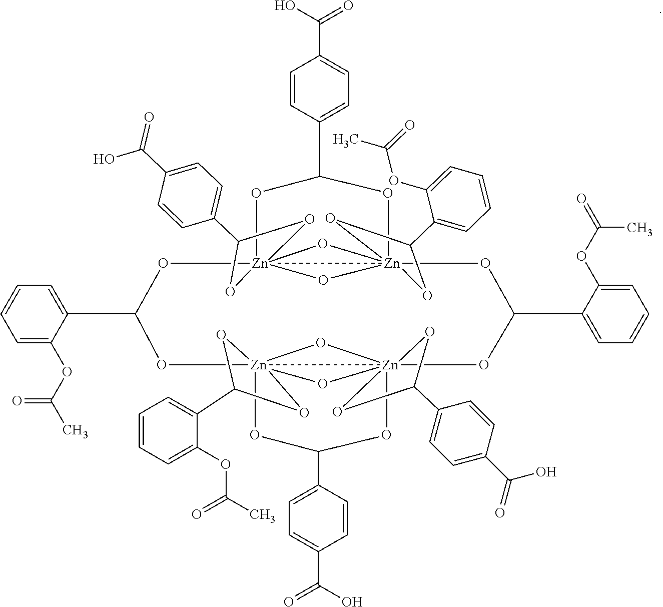

In certain embodiments, a method for preparing the Zn-MOF material includes subjecting a mixture containing a zinc salt, benzene-1, 4-dicarboxylic acid, 2-acetoxybenzoic acid (also known as aspirin), and a solvent to a heating treatment to allow the zinc salt, the benzene-1, 4-dicarboxylic acid, and the 2-acetoxybenzoic acid to undergo a coordination polymerization reaction, so as to obtain the Zn-MOF material.

An example of the zinc salt may include, but is not limited to, zinc nitrate hexahydrate (Zn(NO₃)₂·6H₂O).

Examples of the solvent may include, but are not limited to, dimethylformamide (DMF) and water.

In certain embodiments, a millimolar ratio of the zinc salt, the benzene-1, 4-dicarboxylic acid, and the 2-acetoxybenzoic acid is 5:1:1.

In certain embodiments, the coordination polymerization reaction is conducted at a temperature of 120° C. for a time period of 24 hours.

According to the present disclosure, the Zn-MOF material may serve as a photocatalyst for the photocatalytic degradation of the tetracycline.

Therefore, the present disclosure provides a method for photocatalytic degradation of tetracycline, which includes subjecting a medium containing tetracycline to a photocatalytic degradation under light in the presence of the aforesaid Zn-MOF material, so as to degrade the tetracycline in the medium.

In certain embodiments, the medium is wastewater.

An example of the light may include, but is not limited to, light with a wavelength greater than 420 nm. Examples of the wastewater may include, but are not limited to, domestic wastewater and agricultural wastewater.

According to the present disclosure, the Zn-MOF material may serve as a catalyst (such as a photocatalyst and a photoelectrocatalyst) for the hydrogen evolution reaction.

Therefore, the present disclosure also provides a method for producing hydrogen, which includes subjecting water to a hydrogen evolution reaction in the presence of the aforesaid Zn-MOF material and an alkaline medium, so as to produce hydrogen.

Examples of the water, but are not limited to, unused water (i.e., fresh water), used water, and regenerated water. Examples of the used water may include, but are not limited to, domestic wastewater, agricultural wastewater, and industrial wastewater.

An example of the alkaline medium may include, but is not limited to, potassium hydroxide.

In certain embodiments, the hydrogen evolution reaction is conducted using an electrochemical device. The electrochemical device includes two spaced-apart electrodes and the alkaline medium. One of the two spaced-apart electrodes includes the Zn-MOF material.

The disclosure will be further described by way of the following examples. However, it should be understood that the following examples are solely intended for the purpose of illustration and should not be construed as limiting the disclosure in practice.

### EXAMPLES

### Preparation Example 1 (PE1)

A label and a cap were removed from a polyethylene terephthalate (PET) bottle, followed by cutting the resultant bottle body into several fragments. The fragments were washed with soap and water, following by placing the thus washed fragments into an oven set at a temperature of 60° C. for a time period of 120 hours for a drying treatment, so as to obtain dried fragments. Next, 2.5 g of the dried fragments were placed into a stainless steel autoclave lined with Teflon, and then 5 mL of ethylene glycol and 50 mL of deionized water were added into the stainless steel autoclave, followed by conducting a hydrothermal process at a temperature of 210° C. for a time period of 8 hours, so as to obtain a mixture. Afterwards, the mixture was subjected to a centrifugation treatment to form the resultant supernatant and precipitate, thereby collecting the resultant precipitate containing benzene-1, 4-dicarboxylic acid. Subsequently, the resultant precipitate was washed with ethanol two times, followed by conducting a drying treatment at a temperature of 80° C. for a time period of 12 hours, so as to obtain a powder of benzene-1, 4-dicarboxylic acid of PE1.

### Example 1 (EX1)

A method for preparing a zinc metal-organic framework (Zn-MOF) material of EX1 includes the following steps (a) to (d).

<Step (a)>

1.485 g (i.e., 5 mmole) of zinc nitrate hexahydrate (Zn(NO₃)₂·6H₂O, serving as a zinc salt), 0.180 g (i.e., 1 mmole) of 2-acetoxybenzoic acid, 0.166 g (i.e., 1 mmole) of the powder of the benzene-1, 4-dicarboxylic acid of PE1, and 30 mL of dimethylformamide (DMF, serving as a solvent) were mixed and stirred for a time period of 30 minutes, so as to obtain a mixture.

<Step (b)>

The mixture was placed into the stainless steel autoclave, followed by subjecting the mixture to a heating treatment at a temperature of 120° C. for a time period of 24 hours to allow the zinc nitrate hexahydrate, the 2-acetoxybenzoic acid, and the benzene-1, 4-dicarboxylic acid in the mixture to undergo a coordination polymerization reaction so as to form a zinc metal-organic framework (Zn-MOF) material, thereby obtaining a first crude product containing the Zn-MOF material and residues of DMF. The Zn-MOF material thus formed included a zinc ion, a benzene-1, 4-dicarboxylic acid ligand coordinated to the zinc ion, and a 2-acetoxybenzoic acid ligand coordinated to the zinc ion.

<Step (c)>

The first crude product was added with ethanol, followed by conducing to a centrifugation treatment using a centrifugal machine to form the resultant supernatant and precipitate, thereby collecting the resultant precipitate containing the Zn-MOF material. Subsequently, the resultant precipitate was repeatedly subjected to the aforesaid centrifugation treatment and collection in sequence for a total of 4 times, so as to obtain a second crude product containing the Zn-MOF material and residues of ethanol, water and DMF.

<Step (d)>

The second crude product was subjected to a first drying treatment at a temperature of 60° C. for a time period of 12 hours to remove residues of ethanol and water therefrom, followed by conducting a second drying treatment under vacuum at a temperature of 110° C. for a time period of 12 hours to remove residues of DMF therefrom, so as to obtain a powder of a Zn-MOF material of EX1.

### Comparative Example 1 (CE1)

The Zn-MOF material of CE1 was prepared in accordance to a method slightly modified from that disclosed in S. M. Mirsoleimani-azizi et a/. (2018), J. Environ. Chem. Eng., doi: 10.1016/j.jece.2018.09.017, and the procedures and conditions in the method were similar to those of EX1, except that: (i) in step (a), 0.180 g (i.e., 1 mmole) of the 2-acetoxybenzoic acid and 0.166 g (i.e., 1 mmole) of the powder of the benzene-1, 4-dicarboxylic acid of PE1 were replaced by 0.320 g (i.e., 2 mmole) of the powder of the benzene-1, 4-dicarboxylic acid of PE1; and (ii) in step (b), the Zn-MOF material in the thus obtained first crude product included the zinc ion and the benzene-1, 4-dicarboxylic acid ligand coordinated to the zinc ion.

### Application Example 1-1 (AE1-1)

In a dark environment, a catalyst solution containing 1.0 mg/mL of the Zn-MOF material of EX1 was dispersed into a tetracycline solution (containing deionized water and tetracycline, pH value: 7.0, tetracycline concentration: 20 ppm) for a time period of 30 minutes, so as to obtain a mixture of AE1-1.

### Application Examples 1-2 to 1-5 (AE1-2 to AE1-5)

The procedures and conditions for preparing the mixtures of AE1-2 to AE1-5 were similar to those of AE1-1, except that: (i) the catalyst solutions used to prepare the mixtures of AE1-2 and AE1-3 had the concentrations of the Zn-MOF material of EX1 of 0.5 mg/mL and 1.5 mg/mL, respectively; and (ii) the tetracycline solutions used to prepare the mixtures of AE1-4 and AE1-5 had the tetracycline concentrations of 10 ppm and 30 ppm, respectively.

### Comparative Application Example 1 (CAE1)

The procedures and conditions for preparing the mixture of CAE1 were similar to those of AE1-1, except that the Zn-MOF material of EX1 was replaced by the Zn-MOF material of CE1.

### Application Example 2 (AE2)

First, 5 mg of the Zn-MOF material of EX1, 970 mL of ethanol, and 30 mL of sulfonated polytetrafluoroethylene (manufacturer: Sigma-Aldrich, model no.: Nafion™) were mixed using an ultrasonicator, so as to obtain a mixture. Next, the mixture was applied to a commercially available nickel foam having a thickness of 0.1 cm, a length of 1.5 cm, and a width of 1.0 cm by a drop-casting method well-known to those skilled in the art, so as to form a coating film having a thickness of 100 nm, a length of 1.0 cm, and a width of 1.0 cm. Subsequently, the coating film was subjected to a drying treatment at a temperature of 60° C. for a time period of 12 hours, so as to obtain an electrode body of AE2. The electrode body of AE2 thus obtained included the commercially available nickel foam and a reaction layer which was disposed on a surface of the commercially available nickel foam and which was formed from the coating film.

### Comparative Application Example 2 (CAE2)

The procedures and conditions for preparing the electrode body of CAE2 were similar to those of AE2, except that the Zn-MOF material of EX1 was replaced by the Zn-MOF material of CE1.

### Property Evaluation

### A. X-Ray Diffraction (XRD) Analysis

The Zn-MOF material of a respective one of EX1 and CE1 was subjected to XRD analysis using an X-ray diffractometer, so as to obtain 20 values as shown in Table 1 below.

### B. Carbon-13 Nuclear Magnetic Resonance (¹³C NMR) Spectroscopy

The Zn-MOF material of EX1 was subjected to ¹³C NMR spectroscopy using a ¹³C NMR spectrometer, so as to obtain a ¹³C NMR spectrum as shown in the FIGURE.

### C. Optical Property Analysis

The Zn-MOF material of a respective one of EX1 and CE1 was subjected to optical property analysis using an UV-visible diffuse reflectance spectrometer, so as to obtain an UV-visible absorption characteristic peak as shown in Table 1 below.

### D. Band Structure Analysis

First, the Zn-MOF material of a respective one of EX1 and CE1 was applied to a glassy carbon electrode, so as to obtain an electronic body. Next, the corresponding Zn-MOF material for the respective one of the electronic bodies of EX1 and CE1 was subjected to electrochemical Mott-Schottky analysis using a Metrohm-Autolab electrochemical workstation which included the electronic body of EX1 or CE1 (serving as a working electrode), an Ag/AgCI electrode (serving as a reference electrode), and a platinum electrode (serving as a counter electrode). The Metrohm-Autolab electrochemical workstation included an electrolyte solution containing 0.5 M of sodium sulfate (Na₂SO₄) and water, and the electrochemical Mott-Schottky analysis was conducted with parameters set to a frequency of 1000 HZ. The results are shown in Table 1 below.

### E. Determination of Specific Surface Area and Porosity

First, the Zn-MOF material of a respective one of EX1 and CE1 with a weight greater than 150 mg was subjected to a degassing treatment at a temperature of 120° C. for a time period of 12 hours, so as to obtain a test sample of a respective one of EX1 and CE1.

Next, the test sample of the respective one of EX1 and CE1 was subjected to determination of specific surface area and porosity using a Brunauer-Emmett-Teller (BET) surface area analyzer (manufacturer: Quantachrome Instruments, Inc., model no.: Nova 2000) under a nitrogen (N2_{(g)}) atmosphere. The results are shown in Table 1 below.

### F. Determination of Tetracycline Degradation Rate

First, the mixture of a respective one of AE1-1 to AE1-5 and CAE1 was subjected to light irradiation at a wavelength greater than 420 nm using a xenon arc lamp in combination with a cut-off filter for a time period of 60 minutes. On the 10^{th}, 20^{th}, 30^{th}, 40^{th}, 50^{th}, and 60^{th} minutes after the start of light irradiation, 2 mL of the thus irradiated mixture of the respective one of AE1-1 to AE1-5 and CAE1 was taken out and served as a test sample. Thereafter, the test sample was subjected to determination of absorbance of tetracycline therein at a wavelength of 371 nm (OD371) using an UV-visible spectrophotometer. Next, the thus obtained OD371 value determined in the test sample was converted to a tetracycline concentration thereof using techniques well-known to those skilled in the art.

Afterwards, the tetracycline degradation rate of the test sample of a respective one of AE1-1 to AE1-5 and CAE1 was calculated using the following Equation (1):

$$A = [ ( {C}_{0} - {C}_{1} ) / {C}_{0} ] \times 100 \% \qquad ( 1 )$$

$$where A = tetracycline degradation rate ( \% )$$

$${C}_{0} = initial tetracycline concentration in tetracycline solution ( ppm )$$

$${C}_{1} = tetracycline concentration in test \\ \\ \\ sample after light irradiation at different time intervals$$

(ppm)

The results are shown in Table 2 below.

### G. Determination of Overpotential of Hydrogen Evolution Reaction

A test sample containing 1 M of potassium hydroxide (serving as an electrolyte) and water was subjected to a hydrogen evolution reaction in the absence or presence of illumination using a Metrohm-Autolab electrochemical workstation which has a three-electrode system including the electrode body of a respective one of AE2 and CAE2 (serving as a working electrode), an Ag/AgCl electrode (serving as a reference electrode), and a platinum electrode (serving as a counter electrode) in accordance with a linear sweep voltammetry test well-known to those skilled in the art, with parameters set to a sweep voltage ranging from 0 V to −1.5 V and a step size of 5 mV, so as to obtain a current-potential curve. Thereafter, the thus obtained current-potential curve was analyzed using techniques well-known to those skilled in the art, so as to determine the overpotential at a current of −10 mA. The results are shown in Table 3 below.

In addition, another test sample containing 1 M of potassium hydroxide (serving as an electrolyte) and water was subjected to determination of overpotential of hydrogen evolution reaction in accordance with the procedures and conditions similar to those of AE2 described above, except that a commercially available nickel foam was used to serve as the working electrode, and the thus obtained overpotential at a current of −10 mA was 200 mV.

### Results

TABLE 1

| Zn-MOF material | | EX1 | CE1 |
|---|---|---|---|
| 2θ values (degree) | | 6.0 | 7.5 |
| | | 8.8 | 8.0 |
| | | 14.7 | 8.8 |
| | | 15.5 | 10.8 |
| | | 17.7 | 14.6 |
| UV-visible absorption characteristic peak (nm) | | 565 | 425 |
| Specific surface area (m²/g) | | 122.40 | 56.53 |
| Porosity (%) | | 27.0 | 36.8 |
| Band structure | Flat band potential (eV, | −0.862 | −0.759 |
| analysis | compared to standard | | |
| | hydrogen electrode) | | |
| | Valence band (eV) | +1.748 | +2.111 |
| | Conduction band (eV) | −0.962 | −0.859 |
| | Band gap (eV) | 2.71 | 2.97 |

TABLE 2

| | | AE1-1 | AE1-2 | AE1-3 | AE1-4 | AE1-5 | CAE1 |
|---|---|---|---|---|---|---|---|
| Zn-MOF material | | EX1 | | | | | CE1 |
| Tetracycline | 10^{th} minute | 47.18 | 24.87 | 38.08 | 56.21 | 32.08 | 28.50 |
| degradation | 20^{th} minute | 66.10 | 48.73 | 66.80 | 77.26 | 54.34 | 48.66 |
| rate (%) | 30^{th} minute | 76.79 | 63.95 | 76.67 | 82.73 | 68.76 | 60.18 |
| | 40^{th} minute | 80.91 | 71.36 | 81.61 | 86.10 | 74.95 | 69.20 |
| | 50^{th} minute | 84.62 | 76.29 | 82.84 | 87.78 | 79.89 | 73.30 |
| | 60^{th} minute | 86.67 | 79.17 | 84.08 | 88.22 | 81.54 | 76.20 |

TABLE 3

| | | AE2 | CAE2 |
|---|---|---|---|
| Zn-MOF material | | EX1 | CE1 |
| Overpotential at | Absence of illumination | 190 | 197 |
| current of −10 mA | Presence of illumination | 168 | 206 |
| (mV) | | | |

Referring to the FIGURE, the ¹³C NMR spectrum showed that the Zn-MOF material of EX1 included zinc ions, benzene-1, 4-dicarboxylic acid ligands coordinated to the zinc ions, and 2-acetoxybenzoic acid ligands coordinated to the zinc ions.

Referring to Table 1, the flat band potential, valence band, conduction band, and band gap of the Zn-MOF material of EX1 were substantially less than those of CE1. In addition, the Zn-MOF material of EX1 could absorb light with a wavelength greater than 420 nm (e.g., 565 nm), whereas the Zn-MOF material of CE1 merely absorbed light with a relatively short wavelength (e.g., 425 nm). These results demonstrate that the Zn-MOF material of EX1 is capable of enhancing electron transport efficiency, elevating reactivity in specific reduction or oxidation reactions (e.g., ·O₂_{^{−}} easily formed), and achieving electron excitation at lower light energies (i.e., light with a relatively long wavelength), thereby having potential to operate efficiently at lower energies in photocatalytic and electrocatalytic applications.

Referring to Table 2, the tetracycline degradation rates from the 20^{th} minute to the 60^{th} minute for the mixture of a respective one of AE1-1 to AE1-5, which was prepared using the Zn-MOF material of EX1, were substantially greater than those of CAE1, which was prepared using the Zn-MOF material of CE2. These results indicate that the Zn-MOF material of EX1 can exhibit a relatively high degradation rate of tetracycline and hence can effectively remove the tetracycline.

Referring to Table 3, in the absence and presence of illumination, the overpotentials at the current of −10 mA for the electrode body of AE2, which was prepared using the Zn-MOF material of EX1, were substantially less than those of CAE2, which was prepared using the Zn-MOF material of CE2. These results demonstrate that the Zn-MOF material of EX1 enables hydrogen to be produced through the hydrogen evolution reaction with low energy consumption.

Summarizing the above test results, it is clear that by virtue of both the benzene-1, 4-dicarboxylic acid ligand and the 2-acetoxybenzoic acid ligand coordinated to the zinc ion, the Zn-MOF material of the present disclosure can exhibit the relatively high degradation rate of the tetracycline which effectively removes the tetracycline, and enables production of hydrogen through the hydrogen evolution reaction with low energy consumption.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, the one or more features may be singled out and practiced alone without the another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A zinc metal-organic framework (Zn-MOF) material, comprising:
a zinc ion;
a benzene-1, 4-dicarboxylic acid ligand coordinated to the zinc ion; and
a 2-acetoxybenzoic acid ligand coordinated to the zinc ion;
wherein the benzene-1, 4-dicarboxylic acid ligand is derived from benzene-1, 4-dicarboxylic acid which is formed by subjecting a waste polyethylene terephthalate (PET) to an alcoholysis reaction.

2. The Zn-MOF material as claimed in claim 1, wherein a millimolar ratio of the benzene-1, 4-dicarboxylic acid ligand to the zinc ion is 2:5.

3. The Zn-MOF material as claimed in claim 1, wherein a millimolar ratio of the 2-acetoxybenzoic acid ligand to the zinc ion is 2:5.

4. A method for photocatalytic degradation of tetracycline, comprising:
subjecting a medium containing tetracycline to a photocatalytic degradation under light in the presence of the Zn-MOF material as claimed in claim 1, so as to degrade the tetracycline in the medium.

5. The method as claimed in claim 4, wherein the medium is wastewater.

6. A method for producing hydrogen, comprising:
subjecting water to a hydrogen evolution reaction in the presence of the Zn-MOF material as claimed in claim 1 and an alkaline medium, so as to produce hydrogen.
